(19) United States
(12) Patent Application Publication
(10) Pub. No.: US 2011/0031902 A1
(43) Pub. Date: Feb. 10, 2011

(54) INVERTER DEVICE

(76) Inventors: Tohru Hirohashi, Tokyo (JP); Yoshitake Inami, Tokyo (JP); Nobuaki Ito, Tokyo (JP)

Correspondence Address: WENDEROTH, LIND & PONACK, L.L.P., 1030 15th Street, N.W.,, Suite 400 East, Washington, DC, 20005-1503, US

(21) Appl. No.: 12/988,373

(22) PCT Filed: Apr. 15, 2009
(86) PCT No.: PCT/JP2009/001734

§ 371 Date: Oct. 18, 2010

(30) Foreign Application Priority Data
Apr. 24, 2008 (JP) 2008-113961

(51) Int. Cl. H05B 37/02

(52) U.S. Cl. 315/307

(57) ABSTRACT

An object of the present invention is to provide an inverter device that can readily prevent flickering on a light emitting apparatus even when the light emission level thereof lowers. To achieve the object, an inverter device according to the present invention includes a rectifier (2) that performs full-wave rectification on AC power (1), a switcher (3) that switches pulsating power having a cycle that is one-half the cycle of the AC power having undergone the full-wave rectification in the rectifier (2), a transformer (4) having a primary side to which the high-frequency power provided by the switcher (3) is inputted and a secondary side from which boosted AC power is outputted as supplied power to a light emitting apparatus (6), and a controller that controls the current of the supplied power by using the pulse width of an ON signal that activates the switching and is sent to the switcher (3). The controller transmits the ON signal to the switcher (3) at least twice in a single cycle of the pulsating power.

### TECHNICAL FIELD

The present invention relates to an inverter device for producing a high AC voltage used to turn on a light emission apparatus, such as a cold-cathode tube, and adjust the level of light from the light emission apparatus.

### BACKGROUND ART

In general, an inverter device for turning on a cold-cathode tube incorporated as a light source of a liquid crystal display performs full-wave rectification on commercial AC power to produce smoothed DC power, performs PWM control on the DC power based on a control signal from a light-level adjusting circuit and a current fed back to the cold-cathode tube, boosts the DC power to have a high voltage ranging from 1000 to 2000 V in an inverter transformer, and outputs the high AC voltage to the cold-cathode tube.

In the inverter device described above, to suppress harmonics produced when pulsating power having undergone full-wave rectification is smoothed, several measures are taken. For example, the cold-cathode tube is turned on by using an active filter circuit, a choke input method, or any other component or method to rectify commercial AC power into DC voltage and switching the DC voltage in a transformer to boost the DC voltage.

For example, Patent Document described below proposes a backlight control apparatus including a power supply that converts AC power into DC power in switching operation, an inverter that uses the output from the power supply as DC power and converts the DC voltage into AC voltage to turn on a lamp, a switch that turns on and off the inverter, a frequency detector that detects the sections of the waveform having undergone full-wave rectification that are before and after a point where the voltage becomes zero and outputs a signal during the detected sections, and control means for controlling the switch to be turned off in a period during which the frequency detector outputs the signal.

The backlight control apparatus described above is advantageous in that the lamp will not be turned on in a period during which no power conversion is performed in a transformer because the point of the voltage waveform having undergone full-wave rectification where the voltage becomes zero is detected and the detected point is used as a sync signal to produce a period by which a PWM control signal is delayed.

In the backlight control apparatus of this type, the following procedure is typically carried out, as shown in FIG. 6: Full-wave rectification is performed on AC power to form pulsating power having a cycle that is one-half the cycle of the AC power. The resultant pulsating power is smoothed into DC power. The DC voltage is switched by using a pulse width p corresponding to a light-level adjustment input according to the light emission level of a cold-cathode tube to convert the DC voltage into an AC voltage. The AC voltage is boosted to turn on the cold-cathode tube.

In this process, an ON signal for carrying out the switching is produced once in a single cycle of the pulsating power. That is, when AC power having a frequency of 50 Hz (or 60 Hz) is used, a pulse for activating the switching operation is produced at a cycle of 100 Hz (or 120 Hz).

In particular, when the light emission level (brightness level) of the cold-cathode tube decreases, that is, when the brightness of a liquid crystal screen decreases, the pulse width p of the switching ON signal decreases, and the length t of the OFF section increases. As a result, the cycle at which the cold-cathode tube is turned on increases and hence flickering occurs disadvantageously on the liquid crystal screen.

### Prior Technical Documents

### Patent Document

### [Patent Document 1] Japanese Patent Laid-Open No. 2004-303431

### SUMMARY OF THE INVENTION

The present invention has been made in view of the circumstances described above. An object of the present invention is to provide an inverter device that can readily prevent flickering on a light emitting apparatus even when the light emission level thereof lowers and can hence stabilize adjusted brightness of the light emitting apparatus.

To achieve the object described above, an inverter device according to a first aspect of the present invention includes a rectifier that performs full-wave rectification on AC power, a switcher that switches pulsating power having a cycle that is one-half the cycle of the AC power having undergone the full-wave rectification in the rectifier, a transformer having a primary side to which the high-frequency power provided by the switcher is inputted and a secondary side from which boosted AC power is outputted as supplied power to a light emitting apparatus, and a controller that controls the current of the supplied power by using the pulse width of an ON signal that activates the switching and is sent to the switcher. The controller transmits the ON signal to the switcher at least twice in a single cycle of the pulsating power.

In a second aspect of the present invention, the controller includes a control circuit that transmits the ON signal to the switcher, a voltage detecting portion that detects the voltage of the pulsating power, and a light-level adjusting circuit to which a light-level adjustment signal corresponding to the light emission level of the light emitting apparatus is inputted and which sets a low-voltage section of the pulsating power detected by the voltage detecting portion as an OFF section used to adjust the light level and transmits a control signal based on the light-level adjustment signal to the control circuit. The control circuit transmits the ON signal at least twice in the OFF section in a single cycle of the pulsating power.

In a third aspect of the present invention, the control circuit transmits the ON signal at least twice in a single cycle of the pulsating power when the light-level adjustment signal inputted to the light-level adjusting circuit has a level lower than that of the light-level adjustment signal corresponding to a preset light emission level of the light emitting apparatus.

In a fourth aspect of the present invention, the control circuit sets a lower-limit level at both ends of the OFF section of the pulsating power signal detected by the voltage detecting portion and sets higher-limit levels corresponding to the magnitude of the light-level adjustment signal with respect to the lower-limit levels so that the center of the OFF section is synchronized and the ON signal is transmitted in front and rear portions of the OFF section.

In the inverter device according to the present invention, since the controller transmits the ON signal used to adjust the light level to the switcher at least twice in a single cycle of the pulsating power, it is readily possible to prevent the period during which the light emitting apparatus is turned on from increasing, which otherwise leads to flickering on the light emitting apparatus, even when the light emission level of the light emitting apparatus lowers. The brightness adjustment of the light emitting apparatus can thus be stabilized.

Further, in the present invention, since the pulsating power obtained by performing full-wave rectification on AC power in the rectifier is directly switched, and the transformer boosts the resultant high-frequency power to form high-voltage AC power to be supplied, a ripple component produced when the full-wave rectification is performed lowers the output in the low-voltage range and hence produces a section where the PWM control does not work.

To address the problem, in the second aspect of the present invention, since the low-voltage range is synchronized with the OFF section for light level adjustment in the low-voltage section of the pulsating power detected by the voltage detecting portion, a simple control can prevent the light emitting apparatus from being turned on in a section where no power conversion is carried out in the transformer.

Alternatively, the ON signal for light level adjustment may be transmitted at least twice in the OFF section of a single cycle of the pulsating power for not only low light emission levels but also high light emission levels of the light emitting apparatus. At high light emission levels, however, since the pulse width of the ON signal is wide, the cycle at which the light emitting apparatus is turned on described above will not be advantageously long.

Therefore, more stable control can be achieved by setting in advance a light-level adjustment signal corresponding to the predetermined value of the light emission level and transmitting the ON signal at least twice in the OFF section of the pulsating power when the inputted light-level adjustment signal becomes lower than the preset light-level adjustment signal, as in the third aspect of the present invention.

Further, when the ON signal is transmitted at least twice in the OFF section of the pulsating power, both ends of the OFF section of the pulsating power signal obtained by the full-wave rectification are set as lower-limit levels, and upper limit levels corresponding to the magnitude of the light-level adjustment signal are set with respect to the lower-limit levels so that the center of the OFF section is synchronized and the ON signal is transmitted in front and rear portions of the OFF section, as in the fourth aspect of the present invention, whereby the control can be more readily performed.

### BRIEF DESCRIPTION OF THE DRAWINGS

FIG. 1 shows a schematic configuration of a first embodiment of an inverter device according to the present invention;

FIG. 2A shows the waveform of a voltage Va in the corresponding position in the inverter device shown in FIG. 1;

FIG. 2B shows the waveform of a voltage Vb in the corresponding position in the inverter device shown in FIG. 1;

FIG. 2C shows the waveform of a voltage Vc in the corresponding position in the inverter device shown in FIG. 1;

FIG. 3A shows the voltage waveform of high-voltage AC power supplied to a cold-cathode tube shown in FIG. 1;

FIG. 3B shows the current waveform of the high-voltage AC power supplied to the cold-cathode tube shown in FIG. 1;

FIG. 4 shows control signals in the positions a, b, c, and d in FIG. 1;

FIG. 5 shows a transmission form of control signals corresponding to light level adjustment according to a second embodiment of the present invention;

FIG. 6 shows the relationship between the magnitude of a light-level adjustment input and a control output in a conventional inverter device.

### MODE FOR CARRYING OUT THE INVENTION

### First Embodiment

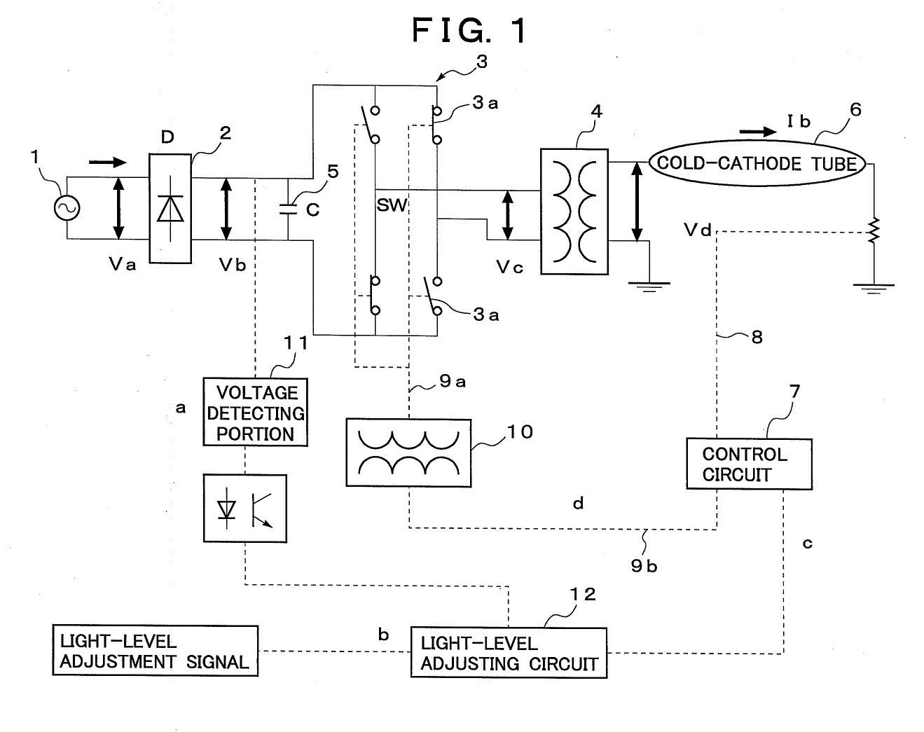

FIGS. 1 to 4 show a first embodiment in which an inverter device according to the present invention is used as an inverter device for turning on a cold-cathode tube.

In FIG. 1, reference character 1 denotes a commercial AC power (60 or 50 Hz) , and the inverter device generally includes a diode bridge (rectifier) 2 that performs full-wave rectification on the AC power, a switcher 3 that switches pulsating power obtained by the full-wave rectification performed in the diode bridge 2, and a transformer 4 having an isolating capability (hereinafter abbreviated to an isolation transformer) that boosts the high-frequency power provided from the switcher 3 and outputs the boosted, high-frequency power as high-voltage AC power.

A capacitor 5 is provided between the diode bridge 2 and the switcher 3. The capacitor 5 is not intended for rectification but is intended to conduct a ripple current produced in the switching operation of the switcher 3. The capacitor 5 can therefore have a capacity that is not influenced by harmonics.

FIG. 1 shows a case using a full-bridge method in which the switcher 3 can be a low-breakdown-voltage switching element 3a and high efficiency is achieved. A half-bridge method or any other suitable method can alternatively be used.

The output side of the switcher 3 is connected to the primary side of the isolation transformer 4, and a cold-cathode tube (light emitting apparatus) 6, which is a part to which the high-voltage AC power is supplied, is connected to the secondary side of the isolation transformer 4.

The inverter device further includes a controller for controlling the switching operation of the switching element 3a in the switcher 3.

The controller includes a control circuit 7 that controls the switching operation in the switcher 3 by performing PWM (Pulse Width Modulation) control, and a feedback circuit 8 that detects the current flowing through the cold-cathode tube 6 and feeds the current back is incorporated in the control circuit 7.

A drive transformer 10 having an isolating capability (hereinafter abbreviated to an isolation drive transformer) is interposed between control circuits 9a and 9b between the control circuit 7 and the switcher 3. The isolation drive transformer 10 is intended to isolate the side where the control circuits 9a is present from the side where the control circuit 9b is present so that the cold-cathode tube 6 and the control circuit 7 work as secondary-side parts. The isolation drive transformer 10 therefore does not need to work as a step-up or step-down transformer between the control circuits 9a and 9b.

The controller further includes a voltage detector including a voltage detecting portion 11 that detects the pulsating power obtained by the full-wave rectification performed in the diode bridge 2 and a light-level adjusting circuit 12 to which a light-level adjustment signal corresponding to the light emission level of the cold-cathode tube 6 is inputted from a brightness adjuster (not shown) and which transmits a control signal for synchronizing a low-voltage section detected in the voltage detecting portion 11 with a switching OFF section in the PWM control in the control circuit 7.

The low-voltage section described above is set in advance in such a way that it sufficiently covers the section where the low-voltage portion of the pulsating power described above causes the current flowing through the cold-cathode tube 6 to be lower than or equal to a control current thereof (for example, a section that covers ±30 degrees on both sides of the point of zero voltage). The light-level adjusting circuit 12 transmits a control signal corresponding to the magnitude of the light-level adjustment signal inputted from the brightness adjuster, which adjusts the brightness of the cold-cathode tube 6, to the control circuit 7 during the section other than the low-voltage section.

Further, the light-level adjusting circuit 12 has a preset light-level adjustment signal value corresponding to a predetermined light emission level of the cold-cathode tube 6 and transmits a control signal to the control circuit 7 at least twice in the OFF section of a single cycle of the pulsating power when the inputted light-level adjustment signal is lower than the preset value. In this way, the control circuit 7 transmits an ON signal to the switcher 3 at least twice in a single cycle of the pulsating power.

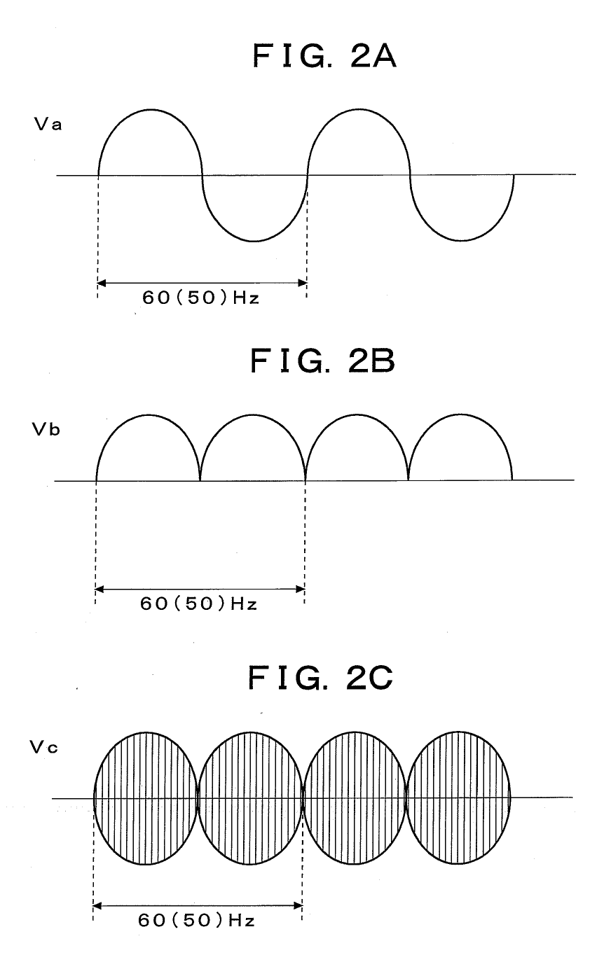

The action of the thus configured inverter device will next be described with reference to the waveforms shown in FIGS. 2A to 4.

First, FIG. 2A shows the voltage waveform of the commercial AC power 1 at 60 or 50 Hz. When the diode bridge 2 performs full-wave rectification on the AC power 1, pulsating power having the voltage waveform shown in FIG. 2B is obtained.

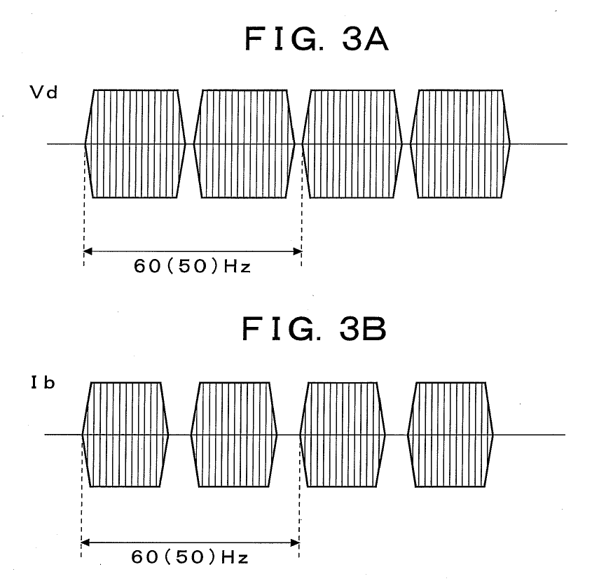

Thereafter, when the pulsating power is switched in the switcher 3, high-frequency power (50 kHz, for example) having the voltage waveform shown in FIG. 2C is obtained. The high-frequency power is then inputted to the primary side of the isolation transformer 4. The secondary side of the isolation transformer 4 then outputs high-voltage AC power having the voltage and current waveforms shown in FIGS. 3A and 3B. The high-voltage AC power turns on the cold-cathode tube 6.

Concurrently, when the light-level adjustment signal from the brightness adjuster, which adjusts the brightness of the cold-cathode tube 6, is inputted to the light-level adjusting circuit 12, the control circuit 7 compares the light-level adjustment signal with the feedback current inputted from the cold-cathode tube 6 through the feedback circuit 8 so that the PWM control is performed on the switching operation of the switcher 3.

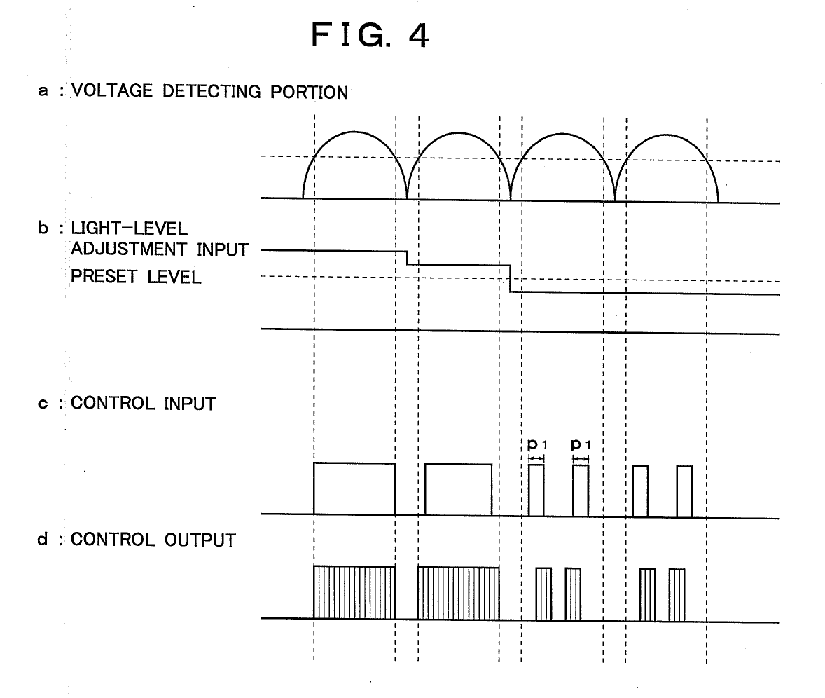

In this process, the voltage detecting portion 11 detects the low-voltage section of the pulsating power obtained by the full-wave rectification performed in the diode bridge 2 as shown at “a” in FIG. 4, and the thus detected low-voltage section is inputted to the light-level adjusting circuit 12. The light-level adjusting circuit 12 then synchronizes the low-voltage section with the switching OFF section in the PWM control. At the same time, the light-level adjusting circuit 12 produces a control signal that sets a switching ON period shown at “c” in FIG. 4 in accordance with the magnitude of the light-level adjustment signal produced in brightness adjustment operation shown at “b” in FIG. 4 and transmits the control signal to the control circuit 7. The control circuit 7 then transmits a switching control signal shown at “d” in FIG. 4 to the switcher 3.

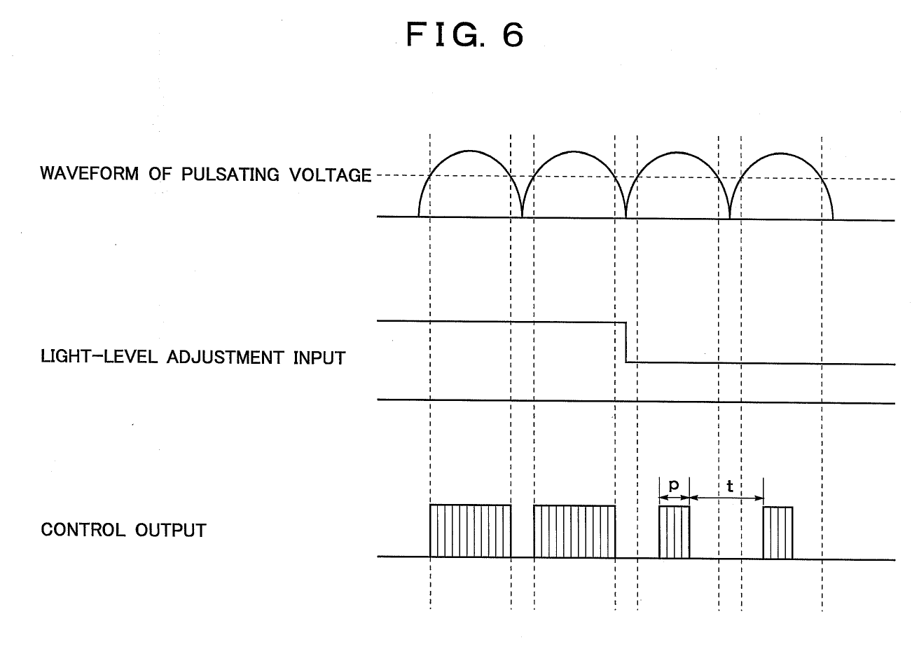

Further, the light-level adjusting circuit 12 transmits the control signal to the control circuit 7 twice in the OFF section of a single cycle of the pulsating power described above when the light-level adjustment signal from the brightness adjuster becomes lower than a preset level. As compared with the conventional light level adjustment control shown in FIG. 6, the pulse width p1 of the ON signal transmitted from the light-level adjusting circuit 12 is one-half the pulse width p shown in FIG. 6.

### Second Embodiment

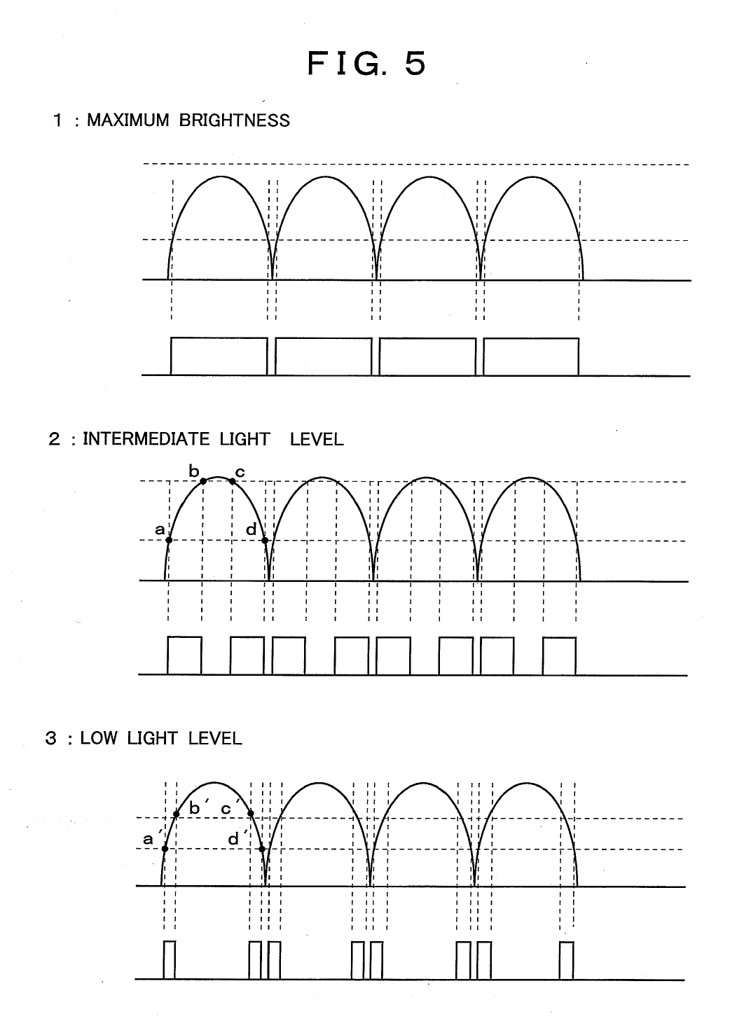

FIG. 5 shows control waveforms transmitted from the controller in a second embodiment of the present invention. It is noted that the other configurations are the same as those shown in FIGS. 1 to 3B.

The inverter device of the present embodiment differs from the inverter device of the first embodiment in terms of the way the controller controls the switcher 3.

That is, in the present embodiment, the ON section is formed of the section from a lower-limit level a, d, a′, or d′ of the pulsating power detected by the voltage detecting portion 11 to an upper-limit level b, c, b′, or c′ corresponding to the magnitude of the light-level adjustment signal, and the light-level adjusting circuit 12 transmits a control signal to the control circuit 7 twice in a single cycle of the pulsating power.

According to the thus configured inverter devices described in the first and second embodiments, the pulsating power obtained by performing the full-wave rectification on the AC power 1 in the diode bridge 2 is directly switched by the switcher 3 to form a high-frequency power, which is then boosted by the isolation transformer 4, and the resultant high-voltage AC power is supplied to the cold-cathode tube 6, whereby the problem of producing harmonics, for example, due to input of a capacitor can be solved.

Additionally, since the cold-cathode tube 6 is a resistive load and hence contains no capacitive and inductive harmonic components, the cold-cathode tube 6 can be smoothly turned on by directly switching the pulsating power described above, boosting the resultant power by the isolation transformer 4, and supplying the boosted high-voltage AC power.

It is therefore unnecessary to incorporate an active filter, a choke coil, or other electronic parts or circuits thereof used to eliminate harmonics, unlike conventional inverter devices, and it is hence possible to produce a high AC voltage from AC power in a simple structure. Further reduction in size is thus achieved.

Further, since the isolation transformer 4 is used as a transformer for boosting the switched, high-frequency power, and the isolation drive transformer 10 is interposed between the control circuit 7 and the switcher 3, the isolation transformer 4 and the isolation drive transformer 10 allow the cold-cathode tube 6 and the control circuit 7 to work as secondary-side parts.

Since the current flowing through the cold-cathode tube 6 is inputted as a feedback current through the feedback circuit 8 to the control circuit 7, and the switcher 3 is controlled in the PWM control process with reference to the feedback current, the current flowing through the cold-cathode tube 6 can be maintained within an appropriate range based on an upper limit specification of the cold-cathode tube 6.

Further, the low-voltage section of the pulsating power that can sufficiently cover the section where the feedback current detected by the voltage detecting portion 11 is lower than or equal to the control current described above is synchronized with the switching OFF section in the PWM control. It is therefore possible in a simple configuration to reliably prevent the supply of power from being unstable due to the light-level adjustment signal.

Additionally, since the light-level adjusting circuit 12 transmits the control signal for activating the switching operation to the control circuit 7 twice in the OFF section of a single cycle of the pulsating power, it is readily possible to prevent the period during which the cold-cathode tube 6 is turned on from increasing, which otherwise leads to flickering on a liquid crystal screen, even when the light emission level of the cold-cathode tube 6 lowers. The brightness adjustment of the liquid crystal screen can thus be stabilized.

### DESCRIPTION OF SYMBOLS

1 AC power
2 diode bridge (rectifier)
3 switcher
4 isolation transformer
6 cold-cathode tube
7 control circuit
8 feedback circuit
10 isolation drive transformer
11 voltage detecting portion
12 light-level adjusting circuit

1. An inverter device comprising:
a rectifier that performs full-wave rectification on AC power;
a switcher that switches pulsating power having a cycle that is one-half the cycle of the AC power having undergone the full-wave rectification in the rectifier;
a transformer having a primary side to which the high-frequency power provided by the switcher is inputted and a secondary side from which boosted AC power is outputted as supplied power to a light emitting apparatus; and
a controller that controls the current of the supplied power by using the pulse width of an ON signal that activates the switching and is sent to the switcher,
wherein the controller transmits the ON signal to the switcher at least twice in a single cycle of the pulsating power.

2. The inverter device according to claim 1,
wherein the controller includes a control circuit that transmits the ON signal to the switcher, a voltage detecting portion that detects the voltage of the pulsating power, and a light-level adjusting circuit to which a light-level adjustment signal corresponding to the light emission level of the light emitting apparatus is inputted and which sets a low-voltage section of the pulsating power detected by the voltage detecting portion as an OFF section used to adjust the light level and transmits a control signal based on the light-level adjustment signal to the control circuit, and
the control circuit transmits the ON signal at least twice in the OFF section in a single cycle of the pulsating power.

3. The inverter device according to claim 1,
wherein the control circuit transmits the ON signal at least twice in a single cycle of the pulsating power when the light-level adjustment signal inputted to the light-level adjusting circuit has a level lower than that of the light-level adjustment signal corresponding to a preset light emission level of the light emitting apparatus.

4. The inverter device according to claim 1,
wherein the control circuit sets a lower-limit level at both ends of the OFF section of the pulsating power signal detected by the voltage detecting portion and sets higher-limit levels corresponding to the magnitude of the light-level adjustment signal with respect to the lower-limit levels so that the center of the OFF section is synchronized and the ON signal is transmitted in front and rear portions of the OFF section.
